(19) United States
(12) Patent Application Publication
(10) Pub. No.: US 2014/0223367 A1
(43) Pub. Date: Aug. 7, 2014

(54) METHOD OF CONTROLLING OPERATION MENU AND APPARATUS

(71) Applicant: FUJITSU LIMITED, Kawasaki-shi (JP)

(72) Inventor: Koki Hatada, Kawasaki (JP)

(73) Assignee: FUJITSU LIMITED, Kawasaki-shi (JP)

(21) Appl. No.: 14/098,709

(22) Filed: Dec. 6, 2013

(30) Foreign Application Priority Data
Feb. 4, 2013 (JP) 2013-019395

(51) Int. Cl. G06F 3/0482; G06F 3/01

(52) U.S. Cl. CPC G06F 3/0482; G06F 3/017
USPC 715/810

(57) ABSTRACT

A method of controlling an operation menu executed by a computer, the method includes: extracting a plurality of operation objects located within a certain range from a cursor position on a display screen; and on the basis of a distance between each of the plurality of operation objects and a corresponding one of a plurality of items displayed as the operation menu, setting corresponding relationships between the plurality of operation objects and the plurality of items.

### CROSS-REFERENCE TO RELATED APPLICATION

This application is based upon and claims the benefit of priority from the prior Japanese Patent Application No. 2013-019395 filed on Feb. 4, 2013, the entire contents of which are incorporated herein by reference.

### FIELD

The embodiments discussed herein are related to controlling an operation menu.

### BACKGROUND

In a general graphical user interface (GUI), an operation object on a display screen is commonly instructed or selected by a mouse, a keyboard, a touch panel, a touch pad, a spatial gesture, and the like. For example, in a spatial gesture, a gesture by a hand or a finger of a user is detected by a sensor disposed on an upper part of a display unit, and a cursor on a display screen is moved in accordance with the gesture.

However, a resolution related to cursor operation is sometimes low, and thus precision of the cursor operation is sometimes low. When the precision of a cursor operation is low, and an area of an operation object, such as a link, a button, an icon, and so on a display screen is small, it becomes difficult for a user to move a cursor to a desired position of the operation object on the basis of a spatial gesture.

Thus, techniques for assisting a user to instruct or select an operation object, such as a link, a button, and the like have been disclosed, for example in Japanese Laid-open Patent Publication No. 2010-282311, Japanese National Publication of International Patent Application No. 2006-520024, and L. Findlater et al., “Enhanced Area Cursors: Reducing Fine Pointing Demands for People with Motor Impairments”, in Proc. of UIST '10, ACM, pp. 153-162 (2010). For example, a technique for newly displaying an operation menu having items corresponding to a predetermined operation object has been disclosed. In the operation menu, a user is allowed to move a cursor position exactly to a position of a desired operation object by selecting an item corresponding to the desired operation object.

### SUMMARY

According to an aspect of the invention, a method of controlling an operation menu executed by a computer, the method includes: extracting a plurality of operation objects located within a certain range from a cursor position on a display screen; and on the basis of a distance between each of the plurality of operation objects and a corresponding one of a plurality of items displayed as the operation menu, setting corresponding relationships between the plurality of operation objects and the plurality of items.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of an example of a user interface using a spatial gesture;

FIG. 2A, FIG. 2B, FIG. 2C, and FIG. 2D are explanatory diagrams of an example of cursor operation using an operation menu;

FIG. 3A and FIG. 3B are first diagrams illustrating the other operation menus;

FIG. 4A, FIG. 4B, and FIG. 4C are second diagrams illustrating the other operation menus;

FIG. 5 is a diagram illustrating an example of a configuration of an operation menu control apparatus according to the present embodiment;

FIG. 6 is a block diagram illustrating an example of an operation menu control apparatus according to the present embodiment;

FIG. 7A and FIG. 7B are diagrams illustrating corresponding relationships between items in an operation menu and operation objects;

FIG. 8A and FIG. 8B are diagrams illustrating the size of an operation menus;

FIG. 9A and FIG. 9B are diagrams illustrating the display position of an operation menus;

FIG. 10 is a flowchart illustrating a processing flow of an operation menu control program;

FIG. 11 is a diagram illustrating extraction processing of a neighboring operation object;

FIG. 12A, FIG. 12B, FIG. 12C, and FIG. 12D are diagrams illustrating distances between operation objects and a cursor position;

FIG. 13A and FIG. 13B are diagrams illustrating an example of setting anchor positions; and

FIG. 14 is an explanatory diagram of calculation of corresponding relationships between operation objects and operation menus.

### DESCRIPTION OF EMBODIMENTS

In a related-art operation menu, sufficient consideration has not been given to corresponding relationships between operation objects and items in the operation menu. Alternatively, an operation menu size and a display position have not been taken into consideration. Accordingly, when a user selects a desired operation object, the user has to search for an item corresponding to the desired operation object in an operation menu, which is troublesome for the user.

Thus, in the technique disclosed in the present embodiment, a more effective operation menu is displayed.

In the following, a description will be given of embodiments of the present disclosure with reference to the drawings. However, the technical scope of the present disclosure is not limited to these embodiments, and extends to the scope of the appended claims and the equivalence thereof.

Spatial Gesture Interface System

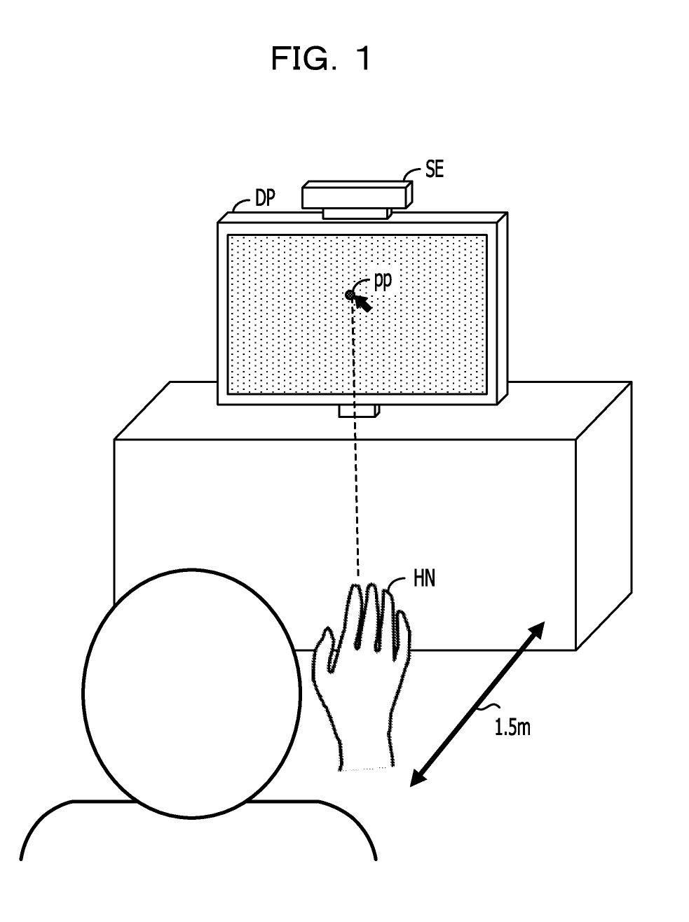

FIG. 1 is a diagram illustrating an example of a system having a user interface using a spatial gesture. In the example in FIG. 1, a user instructs operation on a cursor pp and a button, and the like on a display screen DP on the basis of a gesture of a hand HN.

The system in FIG. 1 includes, for example, a display screen DP of, such as a personal computer, a TV, or the like, and a sensor SE. In this regard, the user and the display screen DP are located about 1.5 meters apart, for example. The sensor SE detects movement of the hand HN of the user, and detects a movement direction and a degree of the movement. And the cursor position pp on the display screen DP is moved on the basis of the movement of the hand HN of the user. The spatial gesture is, for example, movement of the hand HN in the right direction, the left direction, the up direction, or the down direction, closing and opening of the hand HN, jumping of the body, and the like.

A user interface as that in FIG. 1 sometimes has a resolution with a low precision in cursor operation. In this case, the cursor position pp on the display screen DP, which corresponds to the spatial gesture, follows a zigzag track. Accordingly, it becomes difficult for the user to move the cursor position pp to a small area on the display screen DP. For example, the cursor position pp wanders around the object area, and moves to an area of an unintended link and a button. Thus, an operation menu that allows the user to select a desired operation object is used.

Operation Menu

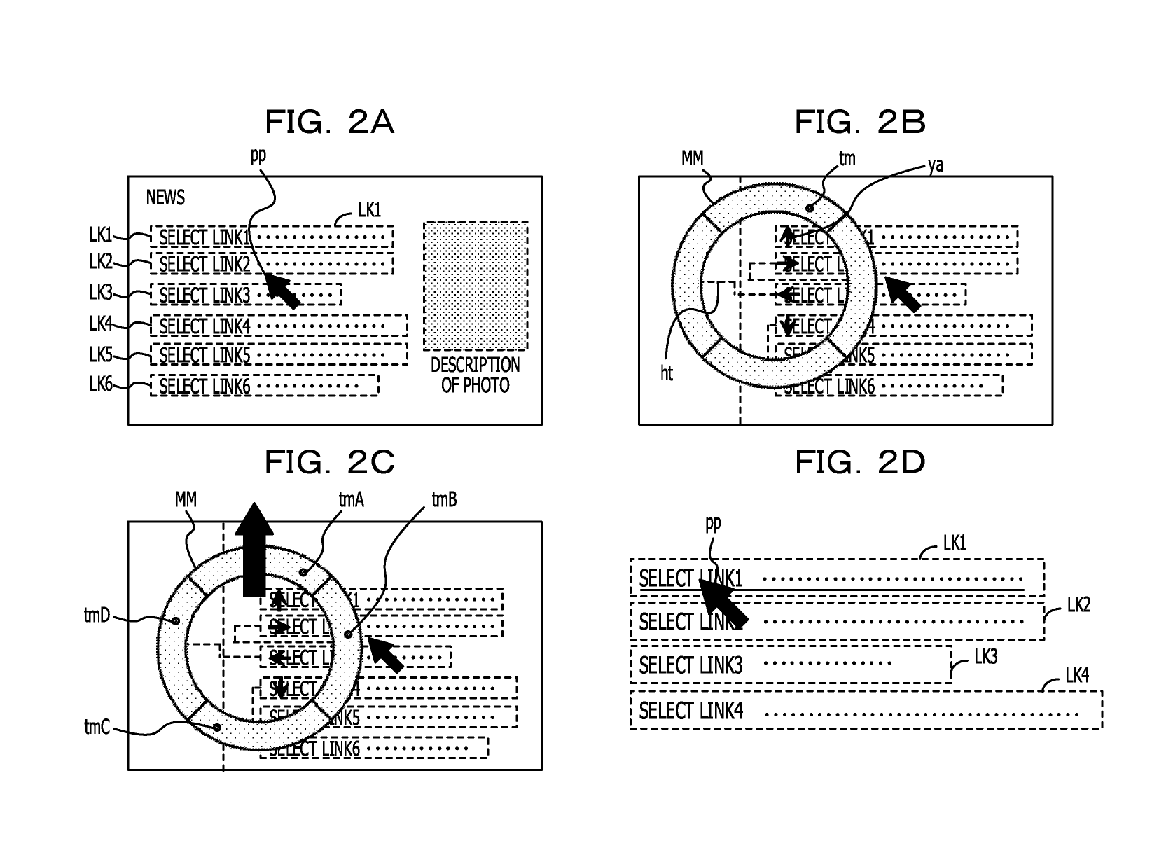

FIG. 2A, FIG. 2B, FIG. 2C, and FIG. 2D are explanatory diagrams of a series of flow of movement operation of a cursor position using an operation menu. FIGS. 2A to 2D illustrate a display screen that changes in time series. The operation menu is a menu having items associated with operation objects on the display screen, respectively, and is displayed on the display screen in an overlapped manner. Also, the items indicate areas that the user is allowed to select. An operation menu has one or a plurality of items.

Operation Object

An operation object is, for example a button, or each of links LK1 to LK6 that is displayed on a screen, each option in a menu bar and a drop-down list, or the like. That is to say, an operation object represents an element that is located on a display screen, and is associated with a function that is executed by a user's selection of the element. In the example in FIG. 2A, the links LK1 to LK6 that are displayed in a Web page are exemplified as operation objects.

In FIG. 2A, first, the user moves the cursor position pp to a neighboring area of the links LK1 to LK6 in the Web page on the display screen on the basis of the spatial gesture. Here, when the user makes a gesture instructing to display an operation menu, the operation objects LK1 to LK4 located in the surroundings of the cursor position pp are extracted. In this example, four operation objects L1 to L4 are extracted. And an operation menu MM as illustrated in FIG. 2B is displayed. In this regard, the gesture instructing to display the operation menu is set in advance.

FIG. 2B illustrates an example of the operation menu MM. The operation menu MM includes four items tm that have a one-to-one relationship with the four extracted operation objects LK1 to LK4, respectively. Also, in the example in FIG. 2B, the operation objects LK1 to LK4 and an item tm are associated by a guide line ht. Thereby, the user is allowed to easily detect an item tm associated with a desired operation object on the basis of the guide line ht. Also, in the example in FIG. 2B, arrows (icons) ya indicating a relative position of an item tm are displayed in overlapping relation with the operation objects LK1 to LK4. Thereby, the user is allowed to easily detect an item tm that is associated with a desired operation object on the basis of the icon.

Next, in FIG. 2C, the user selects an item associated with a desired operation object from items tmA to tmD in the operation menu MM. In this example, the desired operation object is the operation object LK1. The item tmA is associated with the operation object LK1. Also, the item tm is selected, for example, by moving the cursor so as to pass through an arc on which the item tm is displayed in the operation menu MM. Thus, the user, for example makes a gesture that moves a hand upward so as to move the cursor position to move through an upper arc to select the item tmA. Thereby, in FIG. 2D, the operation menu MM disappears, and the cursor position pp moves to the area of the operation object LK1 associated with the item tmA. In this manner, using the operation menu MM, it becomes possible for the user to reliably move the cursor position pp to the position corresponding to the desired operation object LK1.

Here, a specific example will be given about the other examples of the operation menu MM.

Example of Operation Menu

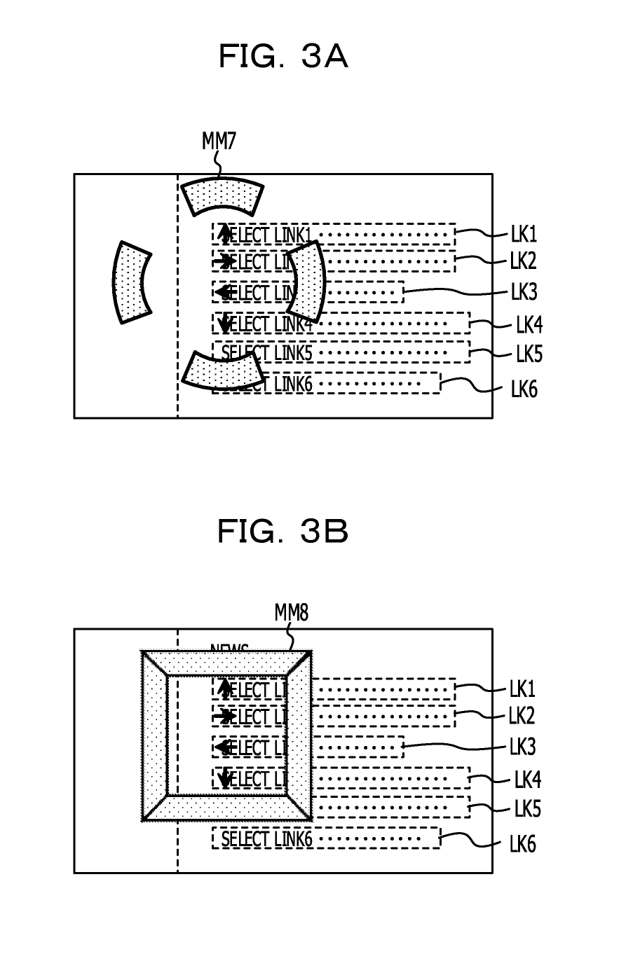

FIG. 3A and FIG. 3B are first example diagrams illustrating the other specific examples of the operation menu MM. A ring-shaped operation menu MM7 in FIG. 3A is divided, and items are disposed in a distributed manner. In this manner, the operation menu MM7 does not have to be a series of areas, and may be constituted by divided areas. Also, an operation menu MM8 in FIG. 3B is not ring-shaped, but is rectangular. In this manner, the operation menu MM8 may be formed in any shape, such as a quadrangle, a hexagon, or the like. In this regard, the number of items in the operation menu MM may be any number. Also, all the items in the operation menu MM may not be associated with the operation objects.

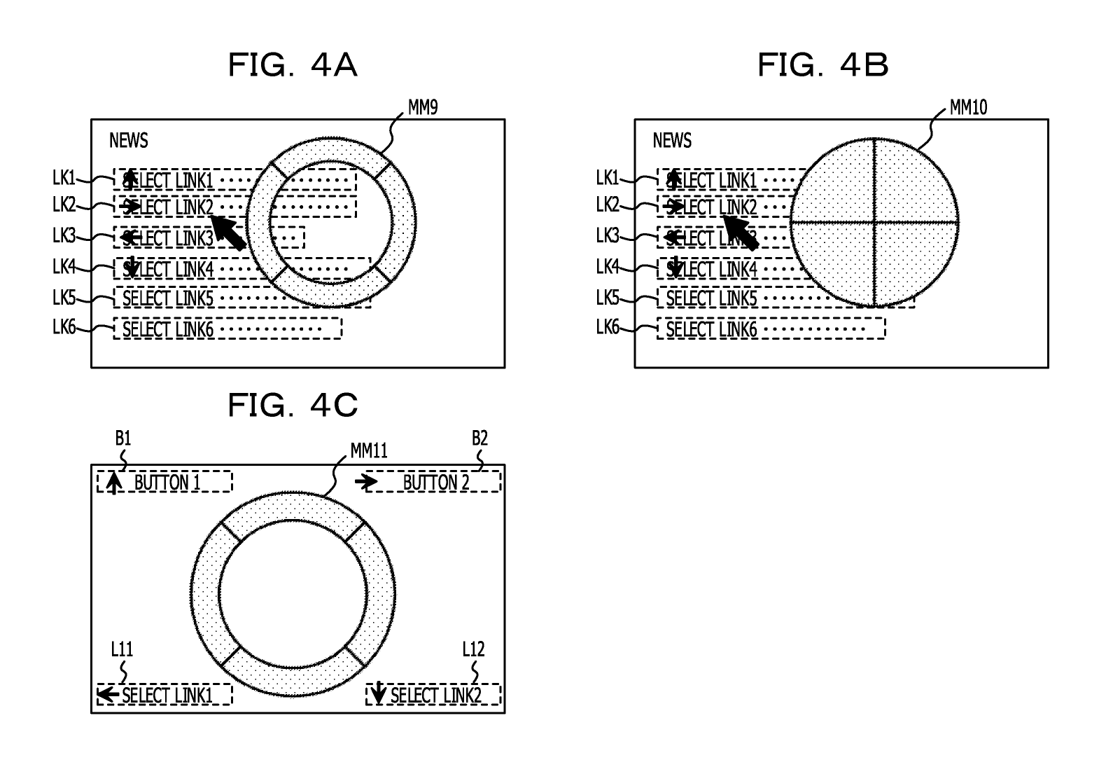

FIG. 4A, FIG. 4B, and FIG. 4C are second example diagrams illustrating the other specific examples of the operation menu MM. An operation menu MM9 in FIG. 4A is displayed not so as to surround the operation objects LK1 to LK4, but is displayed in the vicinity of the operation objects LK1 to LK4. In this manner, an operation menu MM in the present embodiment does not have to be displayed at the surrounding position of operation objects. Also, the operation menu MM10 in FIG. 4B is displayed in the vicinity of the operation objects LK1 to LK4 in the same manner as the operation menu MM9, but has a different shape from the operation menu MM9. The operation menu MM10 is not doughnut-shaped. In this manner, the operation menu MM in the present embodiment does not have to be shaped to surround the operation objects LK1 to LK4.

Also, an operation menu MM11 in FIG. 4C is displayed in an area located in the middle of operation objects B1, B2, L11, and L12 that are located in a distributed manner. In this manner, in the case where the operation objects B1, B2, L11, and L12 are not located in the vicinity, but is located in a distributed manner, the operation menu MM11 may be displayed in the middle of the operation objects. In this regard, in the case where the operation objects B1, B2, L11, and L12 are not close together, it is effective to use the operation menu MM11. This is because even if the operation objects are not located closely together, it is sometimes difficult to move a cursor to the position of a desired operation object on the basis of a gesture. Using the operation menu MM11, it becomes possible for the user to move a cursor position to the position of a desired operation object.

Also, although not illustrated in the figure, even if there is only one operation object associated with an item of the operation menu MM, it is effective to use the operation menu MM. In the same manner as the case where the operation objects are not close together, even if there is only one operation object, it is possible for the user to reliably move the cursor position to the position of the one operation object using the operation menu MM.

Configuration of Operation Menu Control Apparatus

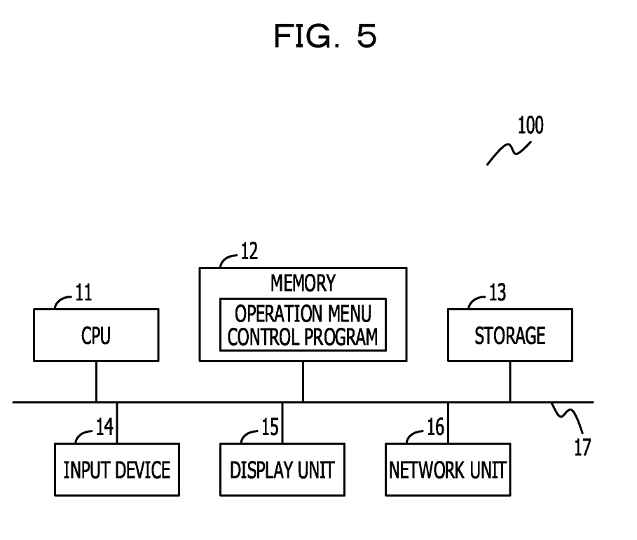

FIG. 5 is a diagram illustrating an example of a hardware configuration of an operation menu control apparatus 100 according to the present embodiment. It is possible to achieve the operation menu control apparatus 100 in FIG. 5 by a general computer, for example. The operation menu control apparatus 100 includes, for example, a central processing unit (CPU) 11, a memory 12, a storage 13, a network unit 16, an input device 14, and a display unit 15. Each unit is mutually connected through a bus 17.

In FIG. 5, the storage 13 stores information related to the overall control of the operation menu control apparatus 100. The network unit 16 performs communication processing with an external apparatus, for example. Also, the input device 14 receives, for example user's gesture information generated by the sensor, and operation information that was input by a keyboard, or the like. The display unit 15 is, for example, a monitor of a computer, a liquid crystal screen of a TV, a screen projected by a projector, or the like. The memory 12 stores, for example an operation menu control program PR that performs operation menu control processing according to the present embodiment, and so on. The CPU 11 performs the operation menu control processing in cooperation with the operation menu control program PR. In this regard, the operation menu control processing may be achieved by hardware that performs the equivalent processing.

In this regard, although the user's gesture information is not illustrated in FIG. 5, the user's gesture information is generated by a sensor, for example a distance sensor, a single-lens camera, a stereo camera, and so on. Alternatively, the user's gesture information may be obtained by a combination of a sensor and an object tracking apparatus. Also, the gesture information may be obtained by a user who wears a terminal apparatus capable of detecting posture and movement using a gyro sensor, an acceleration sensor, an ultrasonic wave, and so on, and may be transmitted from the terminal apparatus to the operation menu control apparatus 100.

Block Diagram of Operation Menu Control Apparatus

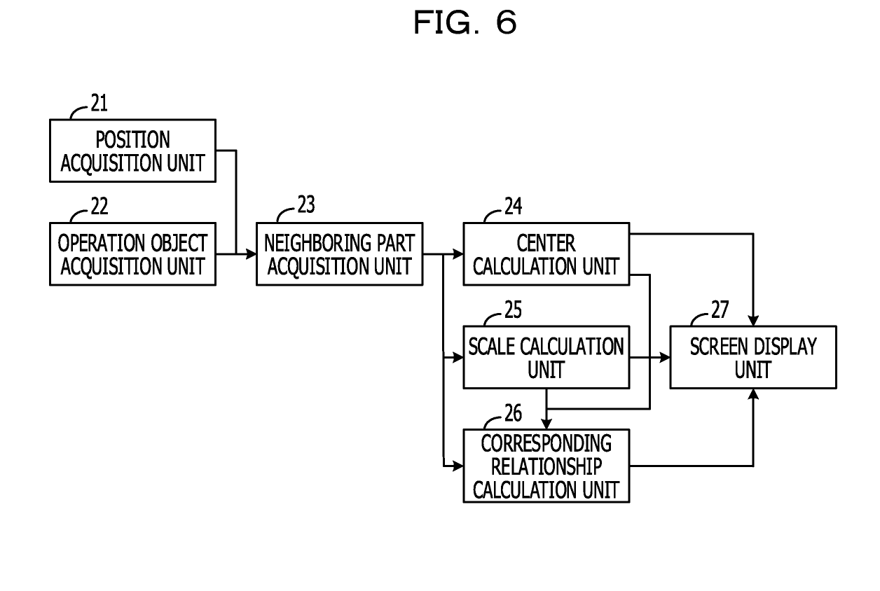

FIG. 6 is an example of a functional block diagram illustrating the operation menu control apparatus 100 according to the present embodiment. The operation menu control apparatus 100 includes, for example a position acquisition unit 21, an operation object acquisition unit 22, a neighboring part acquisition unit 23, a center calculation unit 24, a scale calculation unit 25, a corresponding relationship calculation unit 26, and a screen display unit 27.

The position acquisition unit 21 obtains user's gesture information, and obtains a position of a cursor on a display screen, which is the display unit 15 in FIG. 5. The operation object acquisition unit 22 obtains positions of the operation objects on the display screen, and shapes of the operation objects. The neighboring part acquisition unit 23 extracts an operation object located in the vicinity of the cursor position obtained by the position acquisition unit 21 among the operation objects obtained by the operation object acquisition unit 22. The center calculation unit 24 calculates a center position of an area corresponding to the extracted operation object. The scale calculation unit 25 calculates the size of an operation menu to be displayed. The corresponding relationship calculation unit 26 calculates the corresponding relationship between the extracted operation object and an item of the operation menu.

The screen display unit 27 displays the operation menu with the size calculated by the scale calculation unit 25 on a position on the screen, which is calculated by the center calculation unit 24. Also, at this time, a corresponding relationship between each item of the operation menu and an operation object is set on the basis of the corresponding relationship calculated by the corresponding relationship calculation unit 26.

Here, a description will be given of an operation menu more specifically. Specifically, a description will be given in sequence of corresponding relationships between items of the operation menu and operation objects, a size of the operation menu, and a display position of the operation menu.

Corresponding Relationship Between Operation Objects and Operation Menu Items

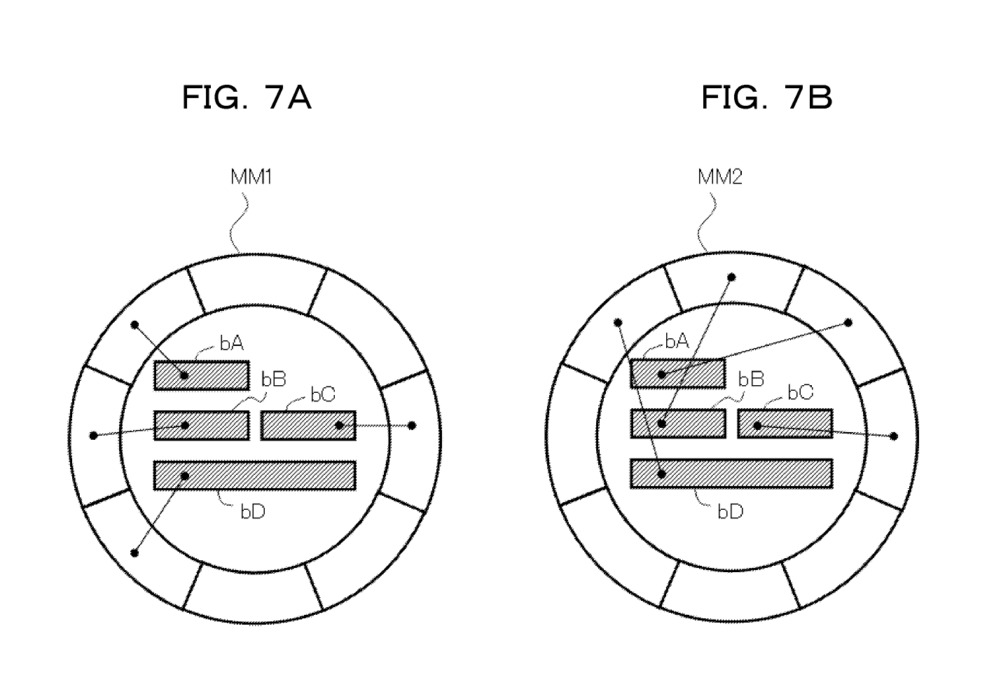

FIG. 7A and FIG. 7B are diagrams illustrating corresponding relationships between items in an operation menu and operation objects. FIG. 7A and FIG. 7B illustrate two operation menus MM1 and MM2 that have different corresponding relationships between operation objects and items, respectively. Each of four operation objects bA to bD is associated with any one of eight items held by the operation menus MM1 and MM2.

FIG. 7A illustrates an operation menu MM1 in which distances between display positions of the operation objects bA to bD and the corresponding items become short, respectively. It is easy for the user to intuitively associate desired operation objects bA to bD with items located at nearest display positions of the operation objects bA to bD, respectively. Thus, in the operation menu MM1, display positions of the items are set on the basis of corresponding relationships that make the sum total of the individual distances of the display positions between the operation objects bA to bD and the corresponding items minimum. Thereby, the user assumes that an item located near a desired operation object is a corresponding item of the desired operation object so that the user is allowed to easily and promptly detect corresponding items of the desired operation objects bA to bD, respectively.

On the other hand, FIG. 7B illustrates an operation menu MM2 in which no consideration is given to the distance of the display positions between the operation objects bA to bD and the corresponding items. In the operation menu MM2, the individual operation objects bA to bD are not exactly associated with the items located at near positions among the items of the operation menu MM2. Thereby, there are cases where regarding corresponding items to the desired operation objects bA to bD, items assumed intuitively by the user are different from items that are actually associated. By the operation menu MM2, the user has to search for items corresponding to desired operation objects bA to bD. And thus it takes time and effort for the user to detect an item.

In this manner, corresponding relationships between the items in the operation menu and the operation objects are taken into consideration so that the user is allowed to more intuitively assume the corresponding relationships between the items and the operation objects. Accordingly, the user is allowed to quickly detect an item corresponding to a desired operation object. In this regard, as illustrated in FIG. 2B, even when an operation object and an item are associated by a guide line ht, if a corresponding relationship is not taken into consideration, the guide lines ht become complicated. Thereby, a corresponding relationship sometimes becomes difficult to be detected all the more. Next, a description will be given of the size of an operation menu.

Size and Position of Operation Menu

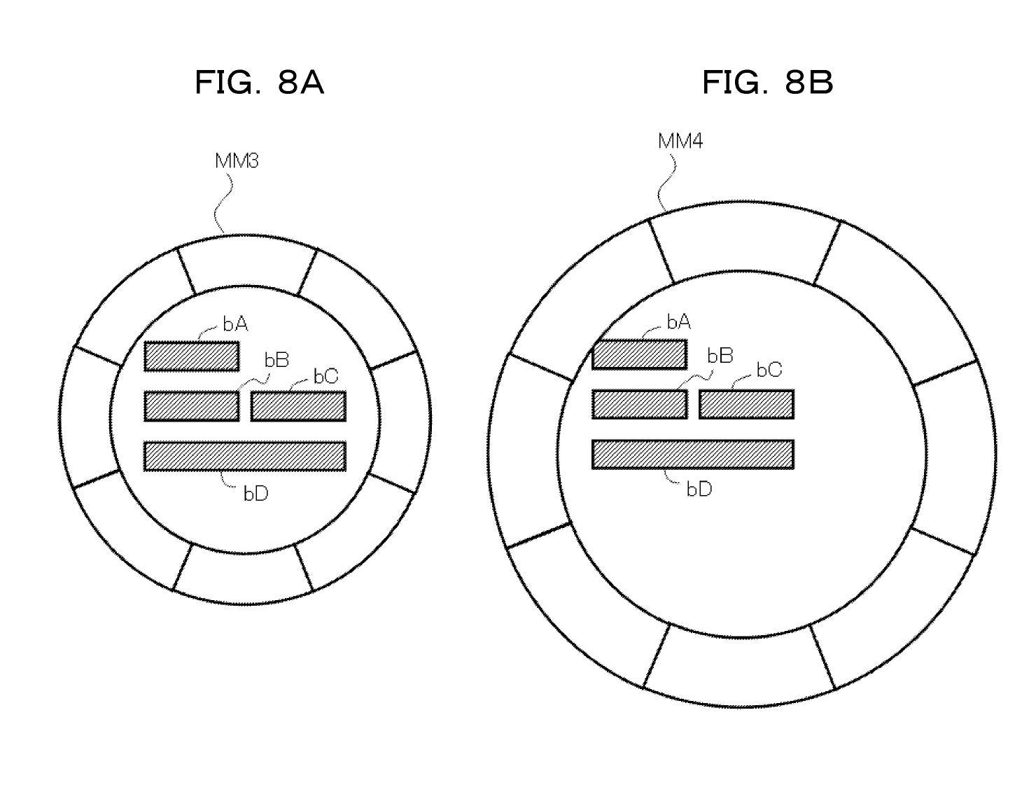

FIG. 8A and FIG. 8B are diagrams illustrating the sizes of operation menus and the display positions. In FIG. 8A and FIG. 8B, two operation menus MM3 and MM4 having different sizes and display positions are displayed. The different operation menus MM3 and MM4 are displayed correspondingly to the same operation objects bA to bD.

FIG. 8A is an example of the operation menu MM3 in which the size and the display position are set on the basis of the operation objects bA to bD. The size of the operation menu MM3 is set on the basis of the certain area of the operation objects bA to bD. Also, the display position of the operation menu MM3 is set on the basis of a center position of the certain area. The certain area of the operation objects bA to bD is a non-overlapping area that does not allow overlapping the operation menu MM3 and allows the user to view. On the basis of the non-overlapping area, the size of the operation menu MM3 is set so as to allow identification of the operation objects bA to bD, and not to be too large with respect to the operation objects bA to bD.

On the other hand, FIG. 8B illustrates an example of the operation menu MM4 in which the size and the display position are not taken into consideration. The size of the operation menu MM4 is needlessly large with respect to the operation objects bA to bD. Also, the center of the operation menu MM4 is located at a position apart from the center of the area corresponding to the operation objects bA to bD. Thereby, it is difficult for the user to identify an item that is near the operation objects bA to bD. Also, although not illustrated in the figure, if the operation menu MM4 is too small with respect to the operation objects bA to bD, the operation menu overlaps the area to be viewed for the operation objects bA to bD. Thereby, it is difficult for the user to identify the operation objects bA to bD.

In this manner, the size of the operation menu is calculated on the basis of the non-overlapping area so that it becomes possible for the user to identify the operation objects bA to bD, and to easily detect items located near the operation objects bA to bD, respectively. Also, the operation menu is displayed such that the center of the operation menu is located in the vicinity of the center of the non-overlapping area so that it becomes possible for the user to easily detect items located near the non-overlapping area of the operation objects bA to bD, respectively.

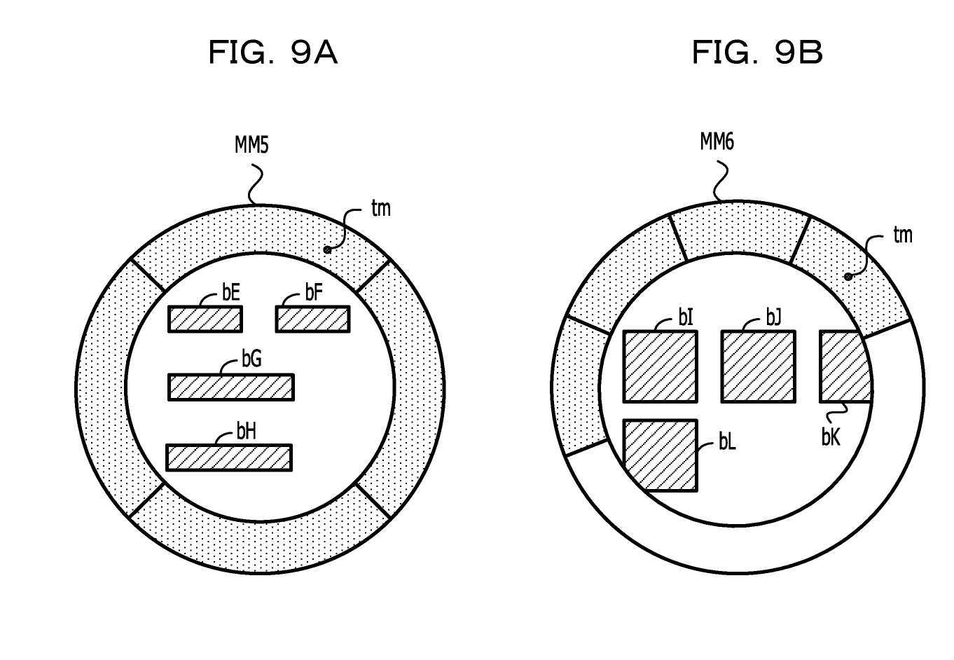

FIG. 9A and FIG. 9B are diagrams illustrating overlapping of the operation menu and the operation objects. FIG. 9A and FIG. 9B display two operation menus MM5 and MM6 having different degrees of overlap with the operation objects. In FIG. 9A, the operation menu MM5 does not overlap the operation objects bE to bH. On the other hand, in FIG. 9B, the operation menu MM6 overlap part of the area of the operation objects bI to bL. In this manner, the operation menu MM may be disposed in a non-overlapping manner with the operation objects, or may be disposed in a partly overlapping manner with the operation objects. However, in the case of overlapping partly, in order to allow viewing the operation objects, the operation menu MM is disposed in order not to overlap at least the non-overlapping area. In this regard, as illustrated in FIG. 9B, not all the area of the operation menu MM6 may be used for the item area tm. Only a partial area of the operation menu may be used for an area tm of the items.

In this manner, regarding an operation menu, a corresponding relationship between an item and an operation object, a size, and a display position are taken into consideration so that the user does not spend time and effort to search for an item corresponding to a desired operation object, and thus the user is allowed to easily and promptly make an assumption. Thus, the operation menu control processing according to the present embodiment includes extraction process, in which one or a plurality of operation objects located within a certain range from a cursor position are extracted on the display screen, and item corresponding relationship calculation process, in which corresponding relationships between the operation objects and the items are calculated on the basis of the distance of the display positions between the extracted operation object and the items. And the operation menu control processing displays an operation menu including items at display positions having a calculated corresponding relationship.

Next, a description will be given of a flow of operation menu control processing according to the present embodiment.

Flow of Operation Menu Control Processing

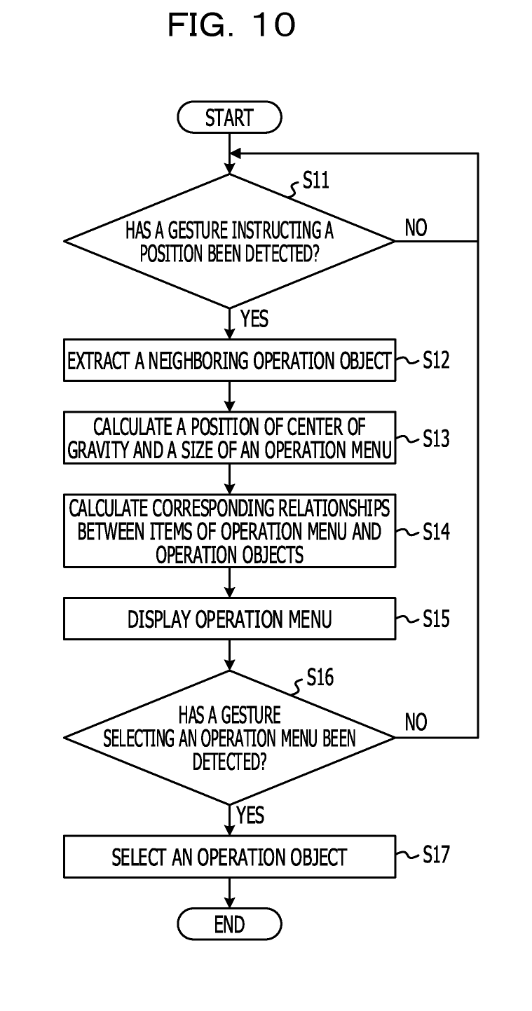

FIG. 10 is a flowchart illustrating a processing flow of an operation menu control program PR according to the present embodiment. First, the position acquisition unit 21 detects movement of a hand of a user, and detects whether a gesture instructing movement of a cursor position has been made or not (S11). If the gesture has been detected (YES in S11), the position acquisition unit 21 calculates a cursor position on the screen, which is corresponding to a position of a hand of the user.

For example, a coordinate system of the user's hand position in space is set as follows. In the space, the horizontal direction of the screen of the display unit is set to the x-axis (positive in the right direction), the vertical direction is set to the y-axis (positive in the down direction), and the normal direction of the screen is set to the z-axis (positive in the departing direction from the screen). The position acquisition unit 21 obtains the coordinates (xₕ, yₕ, zₕ) of the hand position at a predetermined time intervals. And the cursor coordinates (x, y) on the screen are calculated on the basis of the obtained coordinates of the hand position. At this time, the coordinate system of the cursor is set such that the horizontal direction in a screen plane is the x-axis (positive in the right direction), and the vertical direction is the y-axis (positive in the down direction).

Expression 1 is an example of an expression for calculating the coordinates (x, y) of a cursor on the basis of the coordinates (xₕ, yₕ, zₕ) of a hand position. In Expression 1, aₓ, bₓ, a_{y}, and b_{y} are real fixed numbers. The real fixed numbers aₓ, bₓ, a_{y}, and b_{y} are experimentally determined on the basis of the resolution of the display screen, and the like.

$$\{ \begin{matrix}x = {a}_{x} {x}_{h} + {b}_{x} \\ y = {a}_{y} {y}_{h} + {b}_{y}\end{matrix} \qquad ( Expression 1 )$$

Also, the operation object acquisition unit 22 obtains positions and shapes of operation objects on the display screen. The operation object acquisition unit 22 excludes, from the target of processing, an operation object that is moved outside the display screen and is not displayed on the screen by processing, such as panning, zooming, and so on. In this regard, in this embodiment, an example is given of the case where operation objects are rectangle links in a Web page. However, the processing of the operation menu control program PR according to the present embodiment is effective for operation objects other than links and other than rectangular operation objects.

Next, among the operation objects obtained by the operation object acquisition unit 22, the neighboring part acquisition unit 23 obtains an operation object that is located in the vicinity of the calculated cursor position (S12). Specifically, the neighboring part acquisition unit 23 obtains an operation object that is located in a certain distance range with the cursor position as a reference point among the obtained operation objects. A description will be given later of the details of the neighboring part acquisition unit 23 on the basis of a specific example.

Next, the center calculation unit 24 and the scale calculation unit 25 calculate a display position of the operation menu MM, and a size of the operation menu MM, respectively, on the basis of the area of the extracted operation object (S13). Specifically, the center calculation unit 24 and the scale calculation unit 25 calculate the size and the display position of the operation menu MM, respectively on the basis of a non-overlapping area set on the operation objects. The non-overlapping area is an area not to overlap the operation menu MM, and is set for each of the operation objects in the same way. A description will be given later of a specific example of the setting processing of the non-overlapping area, and the calculation processing of the size and the display position of the operation menu MM.

Next, the corresponding relationship calculation unit 26 calculates a corresponding relationship between an item and an operation object on the basis of the distance between the display positions of an item of the operation menu MM and a corresponding operation object (S14). Specifically, the corresponding relationship calculation unit 26 calculates a corresponding relationship that minimizes the sum total of the individual distances between the display positions of the operation objects and the corresponding items. A description will be later given of a specific example of the processing. And the screen display unit 27 displays the operation menu MM on the display screen on the basis of a result of the center calculation unit 24, the scale calculation unit 25, and the corresponding relationship calculation unit 26 (S15). Specifically, the screen display unit 27 displays the operation menu MM at the display position calculated by the center calculation unit 24 with the size calculated by the scale calculation unit 25. Also, the operation menu MM to be displayed includes items at the display positions of the corresponding relationships calculated by the corresponding relationship calculation unit 26. In this regard, the screen display unit 27 may display a guide line ht connecting an item of the operation menu MM and an operation object, and the icon ya as illustrated in FIG. 2B.

Next, the position acquisition unit 21 detects a gesture for selecting an item of the operation menu MM (S16). If the gesture for selecting an item is detected (YES in S16), the cursor is moved to the display position of the operation object corresponding to the selected item, and the operation object is selected (S17). On the other hand, if the gesture for selecting the operation menu MM is not selected (NO in S16), the display of the operation menu MM is terminated, and the processing returns to the detection process of a gesture instructing a position (S11).

In this regard, in the process S15, the screen display unit 27 may display the operation menu MM with the certain size set in advance at the certain display position. That is to say, the screen display unit 27 may not pan and zoom the operation menu MM, but may pan and zoom the display contents including the operation objects. In this case, the size and the display position of the operation objects are changed in accordance with the size and the display position of the operation menu MM.

In the case of panning and zooming a display content, the scale calculation unit 25 calculates the size of the operation object such that the operation menu MM with the certain size and the non-overlapping area of the operation object do not overlap each other. That is to say, the scale calculation unit 25 calculates the size of the operation object on the basis of values in inverse proportion to the size of the non-overlapping area. And the display contents (Web page) including at least operation objects are enlarged or contracted on the basis of the calculated size of the operation object. Also, the screen display unit 27 moves the display positions of the display contents such that the center-of-gravity position of the operation menu MM displayed on the certain display position overlap the center-of-gravity position of the non-overlapping area.

In this manner, in the case where the size of the operation menu MM is fixed at the certain size, the size of an operation object is changed (enlarged or contracted) to a size that allows the operation object to be identified, and that allows an item located near the operation object to be easily detected on the basis of the size of the non-overlapping area. Also, in the case where the display position of the operation menu MM is fixed at the certain display position, the display position of an operation object is changed to a display position that allows an operation object located near the item to be more easily detected on the basis of the non-overlapping area. As a result, it becomes possible for the user to more easily and promptly detect an item corresponding to the desired operation object.

In this regard, as the operation menus MM9 and MM10 in FIG. 4A and FIG. 4B, respectively, the operation menu does not have to be disposed by surrounding an operation object. When an operation menu having such a shape is displayed, the display position and the size may not be calculated. The screen display unit 27 displays, for example, operation menus MM9 and MM10 having corresponding relationships that minimize the sum total of the individual distances between the operation objects and the corresponding items, which has been calculated by the corresponding relationship calculation unit 26, in the vicinity of the operation object. At this time, the screen display unit 27 may display the operation menu at a position that does not overlap the non-overlapping area of the operation object.

Also, as the operation menu MM11 in FIG. 4C, when the operation menu M11 is displayed in the middle of a plurality of operation objects, the neighboring part acquisition unit 23 obtains an operation object that is located within a predetermined range from the cursor position. And the center calculation unit 24 and the scale calculation unit 25 display the operation menu having the size not overlapping the non-overlapping area of the extracted operation object at a position not overlapping the non-overlapping area. At this time, the operation menu may be displayed, for example, such that the center-of-gravity position of the operation menu may overlap the center-of-gravity position of the plurality of non-overlapping areas.

Next, a description will be given of processing of each process in the flowchart using a specific example.

Extraction of Neighboring Operation Objects (S12)

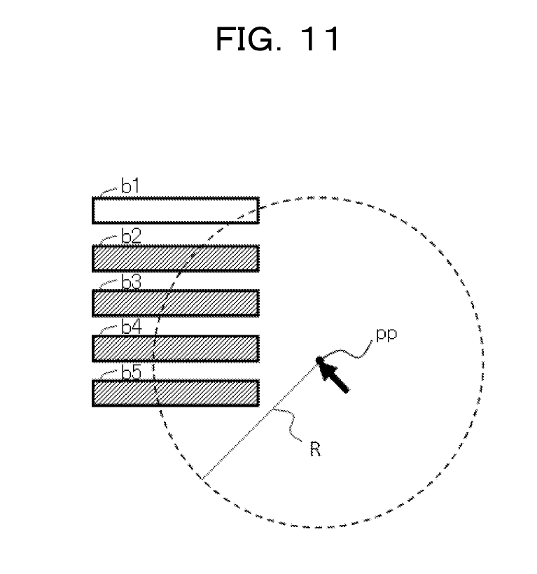

FIG. 11 is a diagram illustrating extraction processing of a neighboring operation object. In FIG. 11, five operation objects b1 to b5 are exemplified. For example, the operation objects b1 to b5 are links in Web pages. In this example, the operation objects b1 to b5 are located within a distance R from the cursor position pp, and a maximum number N of operation objects b1 to b5 are extracted. For example, it is assumed that N=4. In the example in FIG. 11, all the operation objects b1 to b5 are located within a distance R from the cursor position pp, but the number exceeds N pieces (four pieces). Accordingly, among the operation objects b1 to b5, upper four operation objects b2 to b5 that are at a short distance from the cursor position pp, indicated by shading, are extracted.

Expression 2 is an expression representing processing for obtaining operation objects in the vicinity of the cursor position pp. In Expression 2, W denotes all the operation objects, w denotes the operation objects displayed on the display screen (b1 to b5 in the example in FIG. 11) among all the operation objects. Also, P denotes a set of the extracted operation objects, R denotes a fixed number indicating a distance from the cursor position pp. Also, in Expression 2, a function d (w, p) is a function for calculating a distance between the display position of the operation object w located on the display screen and the cursor position pp.

Initialization P←φ

For all w ∈ W if d (w, pp)<R

P←P∪w (Expression 2)

By Expression 2, for operation objects w located on the display screen, if the distance from the cursor position pp is shorter than a fixed value R, the operation object w is added to a set P indicating the operation objects of the extraction target. In this regard, if a maximum number of the operation objects of the extraction target is set to N, upper N pieces of operation objects that have short distances are added to the set P. Next, in Expression 2, a description will be specifically given of a distance calculated in accordance with the function d (w, p).

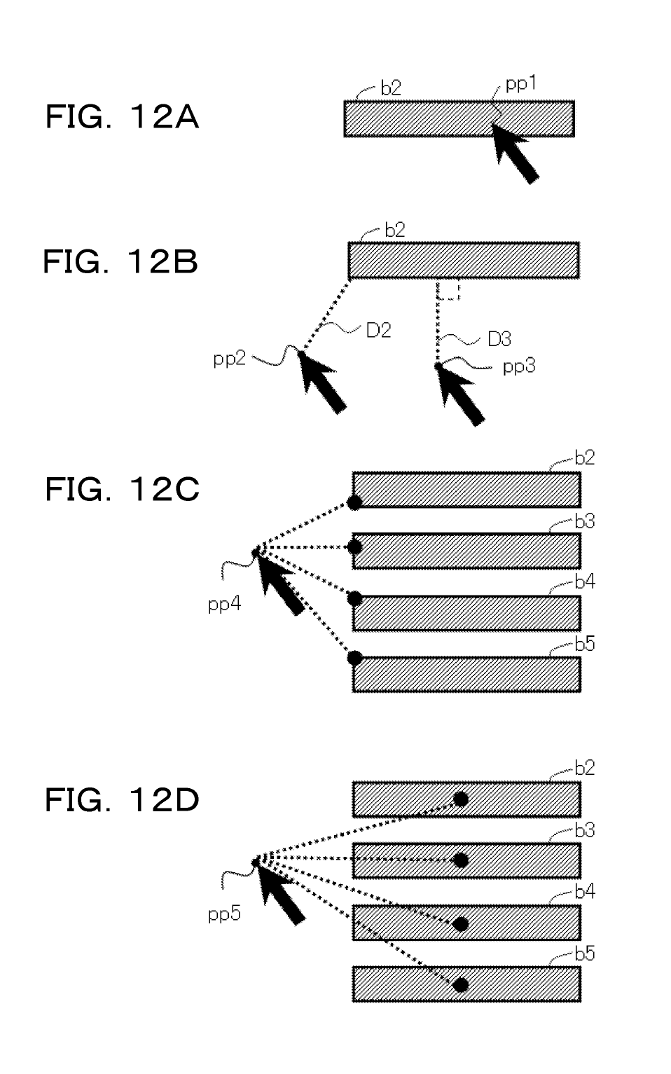

FIG. 12A, FIG. 12B, FIG. 12C, and FIG. 12D are diagrams illustrating distances between operation objects w and a cursor position pp. In this regard, a distance calculated by a function d (w, p) is not limited to this example, and any method may be employed.

FIG. 12A illustrates the case where the cursor position pp1 is located in an area of an operation object b2 (w). In this case, the distance calculated by the function d (w, p) becomes 0. Also, FIG. 12B illustrates the case where cursor positions pp2 and pp3 are located in the surroundings of the operation object b2. In this case, minimum values of the Euclidean distances between any one point in a boundary line of the operation object b2 and the cursor positions pp2 and pp3, respectively are calculated as the distances. For example, in the case of the cursor position pp2, the Euclidean distance that becomes minimum is a distance D2 from a lower left vertex of the operation object b2. Also, in the case of the cursor position pp3, a distance D3 of a perpendicular dropped to a boundary side of the operation object b2 represents a minimum Euclidean distance.

FIG. 12C illustrates minimum values of Euclidean distances in a plurality of operation objects b2 to b5. For the operation objects b2, b4, and b5, distances from the vertices of those operation objects, and for the operation object b3, a distance of the perpendicular to the vertical side of the operation object b3 are calculated as minimum Euclidean distances. Also, FIG. 12D illustrates an example of the case where the distances between the cursor position pp5 and center-of-gravity positions of the operation objects b2 to b5 are calculated as distances of the function d (w, p). In this case, a center-of-gravity position is calculated for each of the operation objects b2 to b5, and a distance from the cursor position pp5 is calculated.

Calculation of Size and Display Position of Operation Menu (S13)

Next, a description will be specifically given of the processing of the process S13 in the flowchart in FIG. 10. A non-overlapping area is set for an operation object in order to calculate the size and the display position of the operation menu. As described before, the size and the display position of the operation menu are calculated on the basis of the non-overlapping areas set for the individual operation objects.

Non-Overlapping Area

The non-overlapping area is a part of or all of the area of an operation object that is not overlapped with the operation menu, and is an area allowed to be viewed from the user. In the present embodiment, a non-overlapping area is set, for example on the basis of one or a plurality of anchor positions that are equally set for each operation object. For example, anchor positions are set at the four corners of a rectangular operation object. In this case, the number of anchor positions that are set for each operation object is four. Alternatively, an anchor position is set to a position located at a certain distance from one vertex (for example, an upper left vertex) of an operation object, or a center-of-gravity position of an operation object. Alternatively, an anchor position is set to a center-of-gravity position of a circumscribed circle or a convex hull of the area of an operation object. In these cases, the number of anchor positions that are set for each operation object is one.

For example, if the display contents of an operation object includes a character string as in the case of a link, a partial area including the start position of the character string in the operation object may be set as a non-overlapping area. If an operation object is expressed by a character string, it becomes possible for the user to estimate the contents of the entire character string by detecting a start portion of the character string. Accordingly, at least the start position of the character string is set to a non-overlapping area so that it becomes possible for the user to identify the contents of the link, which is an operation object. Thereby, the non-overlapping area is kept small, and it becomes possible to avoid increasing the size of an operation menu too much.

Setting Example of Anchor Position

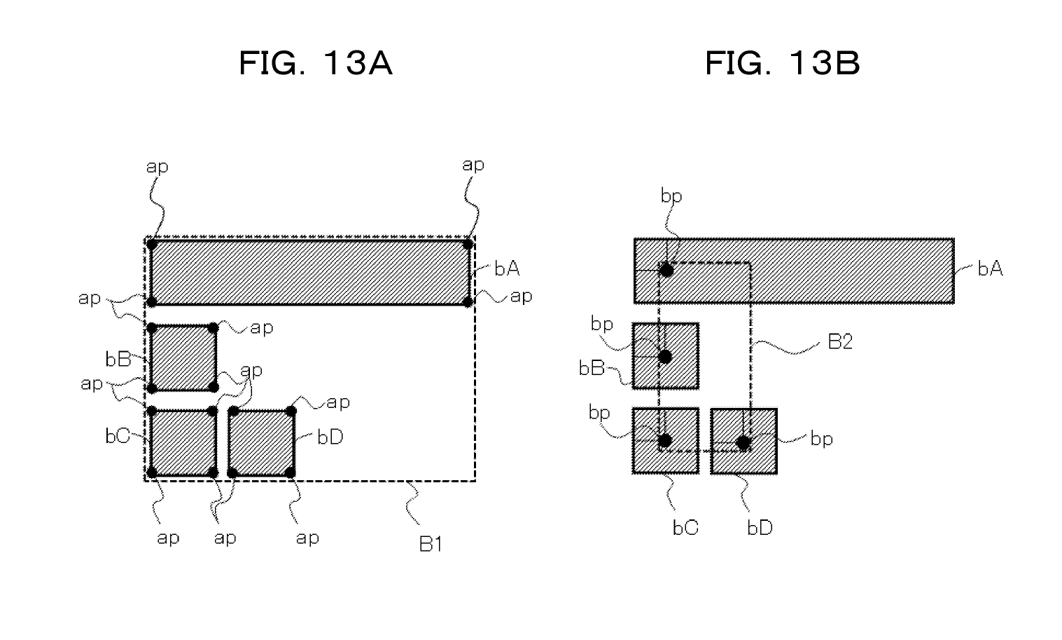

FIG. 13A and FIG. 13B are diagrams illustrating an example of setting anchor positions. In FIG. 13A and FIG. 13B, four operation objects bA to bD are exemplified. FIG. 13A is an example in which anchor positions ap are set at four vertexes of the operation objects. By this method, all the areas of the operation objects bA to bD are set as non-overlapping areas. This indicates the case where it is effective to view all the areas of the operation objects in order for the user to identify operation objects, for example. And a circumscribed rectangle B1 that includes all the anchor positions ap is set. Also, FIG. 13B is an example in which anchor positions by are set to positions located at a certain distance from an upper-left vertex of the operation objects. In this case, a partial area of the operation objects bA to bD is set as a non-overlapping area. And a circumscribed rectangle B2 including all the anchor positions by is set.

Next, the size and the display position of the operation menu is calculated on the basis of the sizes of the circumscribed rectangles B1 and B2 that are set. For example, the size of the operation menu is set on the basis of the size of the rectangles produced by disposing margins on the circumscribed rectangles B1 and B2.

Calculation of Size of Operation Menu

Expression 3 is an expression representing a rectangle B′ in which margins are disposed in the circumscribed rectangles B1 and B2 generated in FIG. 13A and FIG. 13B. In Expression 3, coordinates (bx, by) denote upper-left coordinates of the circumscribed rectangles B1 or B2. Also, a value bw denotes a width of the circumscribed rectangles B1 or B2, and a value bh denotes a height of the circumscribed rectangles B1 or B2. In Expression 3, values s1 to s4 are fixed numbers denoting widths of margins corresponding to individual sides of the circumscribed rectangles B1 and B2. Specifically, the value s1 denotes a width of margin in the left direction, the value s2 denotes a width of margin in the up direction, the value s3 denotes a width of margin in the right direction, and the value s4 denotes a width of margin in the down direction. Alternatively, the margin width values s1 to s4 may be set on the basis of the width bw of the circumscribed rectangles B1 or B2, and the height bh. In this case, for example the products of the width bw of the circumscribed rectangles B1 or B2 and a predetermined factor, and the height bh and a predetermined factor are calculated as the margin width values s1 to s4.

$$Circumscribed rectangles B 1 and B 2 = ( bx , by , bw , bh ) \\ \begin{matrix}Rectangle {B}^{′} = ( bx - s 1 , by - s 2 , bw + s 1 + s 3 , bh + s 2 + s 4 ) \\ = ( {b}^{′} x , {b}^{′} y , {b}^{′} w , {b}^{′} h )\end{matrix} \qquad ( Expression 3 )$$

Next, the size of the operation menu is calculated on the basis of the width b′w and the height b′h of the rectangle B′ that are calculated by Expression 3. The width and the height of the operation menu is calculated, for example in proportion to the value of the function Max (b′w, b′h). The function Max (b′w, b′h) is a function for calculating a higher value between the width b′w and the height b′h of the rectangle B′. For example, in the case where the operation menu is a ring-shaped operation menu, a higher vale between the width b′w and the height b′h of the rectangle B′ is calculated as a diameter of the operation menu. Alternatively, a size in proportion to the higher vale between the width b′w and the height b′h of the rectangle B′ is calculated as a diameter of the operation menu.

However, the calculation of the menu size is not limited to this example. For example, the width and the height of the operation menu may be calculated in proportion to the length of a diagonal of the rectangle B′. Also, the size of the operation menu may be calculated not in proportion to the size of the rectangle B′ provided with margins, but in proportion to the length of diagonals of the circumscribed rectangle B1 or B2. In this manner, the size of the operation menu is calculated in proportion to a non-overlapping area, which is a part of or all of the area of each operation object, and does not overlap the operation menu. Thereby, it becomes possible to calculate the size of the operation menu, which does not overlap the non-overlapping area, and is proportional to the size of the non-overlapping area on the basis of the distribution of disposition of non-overlapping areas.

Calculation of Center Position

Also, the center-of-gravity position of the rectangle B′ is calculated as a center position of the non-overlapping area in the operation object. Thereby, the operation menu is displayed such that the calculated center-of-gravity position of the rectangle B′ overlap the center-of-gravity position of the operation menu. Specifically, the operation menu is displayed such that the center-of-gravity position of the operation menu overlap the coordinates of the center-of-gravity position of the rectangle B′. Thereby, it becomes possible to detect an item located near the operation object. On the other hand, as described above, in the case of not panning and zooming the operation menu, but panning and zooming the display contents including at least the operation object, the display contents are moved such that the center-of-gravity position of the rectangle B′ overlap the coordinates of the center-of-gravity position of the operation menu that is displayed at the certain display position set in advance. In this case, it becomes easy to detect an item located near the operation object in the same manner.

Calculation of Corresponding Relationship (S14)

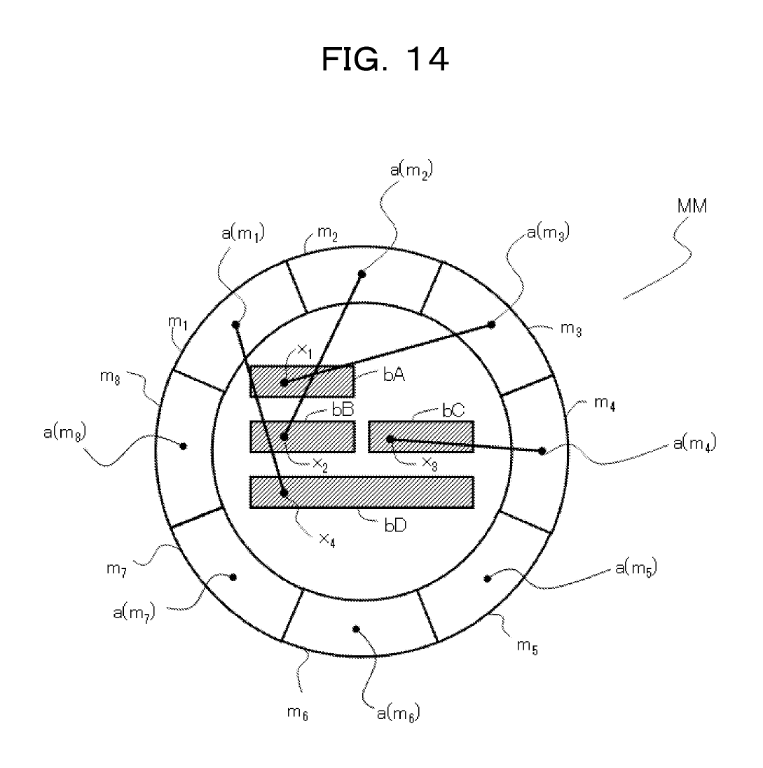

FIG. 14 is an explanatory diagram of calculation of corresponding relationships between operation objects bA to bD and items m₁ to m₈ of an operation menus MM. The four operation objects bA to bD are exemplified. Also, out of the eight items m₁ to m₈ of the operation menu MM, four items are associated with the operation objects bA to bD. In the present embodiment, as the corresponding relationships between the operation objects bA to bD and the items m1 to m8, for example, the corresponding relationships are calculated such that the sum of the distances between representative positions x₁ to x₄ of the operation objects bA to bD and representative positions a (m₁) to a (m₈) of the items m₁ to m₈ becomes minimum. However, the calculation is not limited to this example. The corresponding relationships may be calculated such that at least one distance between the representative positions x₁ to x₄ of the operation objects bA to bD and the representative positions a (m₁) to a (m₈) of the items m₁ to m₈ becomes minimum.

The representative positions x₁ to x₄ of the operation objects bA to bD are positions of individual points that are representative of the areas of the individual operation objects bA to bD. The representative positions x₁ to x₄ are set to, for example, positions having a predetermined distance from specific positions (for example, upper-left vertices) of the areas of the operation objects bA to bD, the center of gravity of the areas to the operation objects bA to bD, and the center position of a circumscribed circle or a convex hull of the area of the operation objects bA to bD. In this example, the representative positions x₁ to x₄ are set to the center-of-gravity positions of the areas of the operation objects bA to bD. Also, the representative positions a (m₁) to a (m₈) of the items m₁ to m₈ are positions of individual points that are representatives of the areas of the individual items m₁ to m₈. To the representative positions a (m₁) to a (m₈) of the items m₁ to m₈, the same description is given as that of the representative positions x₁ to x₄ of the operation objects bA to bD.

Expression 4 is an expression for calculating a corresponding relationship that minimizes the sum of distances between the representative positions x₁ to x₄ of the operation objects bA to bD and the representative positions a (m₁) to a (m₈) of the items m₁ to m₈. In Expression 4, xᵢ (i=1, . . . , N) denotes each of the representative positions x₁ to x₄ of the operation objects bA to bD. Also, in Expression 4, m_{ci} (ci=1, . . . , M) denotes each item in the operation menu, and a (m_{ci}) denotes a representative position in each item. And the function d (xᵢ, a (m_{ci})) denotes a function for calculating a distance between each of the representative positions x₁ to x₄ of the operation objects bA to bD and the representative positions a (m₁) to a (m₈) of the items m₁ to m₈. The function d (xᵢ, a (m_{ci})) is based on, for example a Euclidean distance.

$$E = {\sum }_{i = 1}^{N} d ( {x}_{i} , a ( {m}_{ci} ) ) \qquad ( Expression 4 )$$

On the basis of Expression 4, the sum E of the distances between the representative positions x₁ to x₄ of the operation objects bA to bD and the representative positions a (m₁) to a (m₈) of the items m₁ to m₈ is calculated for each combination of the operation objects bA to bD and the items m₁ to m₈. And a combination that makes the sum E of the distances a minimum value is calculated as a corresponding relationship between the operation objects bA to bD and the items m₁ to m₈. Thereby, the operation objects bA to bD are associated with the corresponding items m₁ to m₈ that are located at near distances.

As described above, a method according to the present embodiment includes an extraction process, in which one or a plurality of operation objects located within a certain range from the cursor position on a display screen are extracted, an item corresponding relationship calculation process, in which corresponding relationships between the operation objects and the items are calculated on the basis of the distances between the display positions of the extracted operation objects and the items, and a display process, in which an operation menu including the items at the display positions of the calculated corresponding relationship.

Thereby, in the present embodiment, it is possible to display an operation menu in which each of the extracted operation object is associated with a near item. It is possible for the user to detect an item located near a desired operation object, and thus to assume an item corresponding to a desired operation object more easily and promptly. Thereby, it is possible to save time and effort to search for an item corresponding to a desired operation object. Thereby, it is possible for the operation menu control program to display an effective operation menu that allows the user to easily select a plurality of operation objects located on a display screen.

Also, in the present embodiment, corresponding relationships in accordance with areas of extracted operation objects are calculated on the basis of the distances between the items and the display positions. Thereby, items in an operation menu are associated with the operation objects that are located closer regardless of the shape and disposition distribution of extracted operation objects. Accordingly, the user is allowed to detect an item corresponding to a desired operation object more easily and promptly regardless of the shape and disposition distribution of extracted operation objects.

Also, in the operation menu control processing according to the present embodiment, the item corresponding relationship calculation process calculates a corresponding relationship that minimizes the sum total of the individual distances of the display positions between the operation objects and the corresponding items. Thereby, it is possible for the operation menu control program to display an operation menu in which the operation objects are associated with the corresponding items located at short distances. Thereby, the user is allowed to detect an item corresponding to a desired operation object more easily and promptly.

Also, the operation menu control processing according to the present embodiment further includes a first size calculation process, in which the size of an operation menu is calculated in proportion to an non-overlapping area that is a part of or all of the area of each of the operation objects and not overlapping the operation menu, and the display process displays the operation menu with the calculated size so as not to overlap the non-overlapping areas. Thereby, it is possible for the operation menu control program to display an operation menu that allows the operation objects to be identified and that has a size allowing the user to detect an item located near the operation object more easily on the basis of the non-overlapping areas. Thereby, the user is allowed to assume an item corresponding to a desired operation object more easily and promptly.

Also, in the operation menu control processing according to the present embodiment, the first size calculation process calculates a second size in proportion to the first size of the circumscribed figure of the non-overlapping area as the size of the operation menu. Thereby, it is possible for the operation menu control program to display an operation menu that allows all the operation objects to be identified and that has a size allowing the user to detect an item located near the operation object more easily on the basis of the distribution of disposition of the non-overlapping areas.

Also, the operation menu control processing according to the present embodiment includes a second size calculation process, in which the operation menu has a certain size, and the size of operation object is calculated in inverse proportion to a non-overlapping area that is a part of or all of the area of each operation object. And a display process changes the size of the operation object to the calculated size, and displays the operation menu so as not to overlap the non-overlapping areas.

In this manner, in the case where the size of the operation menu is fixed at the certain size in advance, it is possible for the operation menu control program to change the size of an operation object to a size that allows the operation object to be identified, and that allows an item located near the operation object to be easily detected on the basis of the size of the non-overlapping area. Thereby, it becomes possible for the user to more easily and promptly detect an item corresponding to an operation object.

Also, in the operation menu control processing according to the present embodiment, display of an operation object includes a character string, and a non-overlapping area is a partial area including the start position of a character string in the operation object. If an operation object is expressed by a character string, it becomes possible for the user to estimate the contents of the entire character string by detecting a start portion of the character string. Accordingly, the operation menu control program sets at least the start position of the character string to a non-overlapping area so that it becomes possible for the user identify the operation objects, and keep the non-overlapping area small, and to avoid increasing the size of an operation menu too much.

Also, the operation menu control processing according to the present embodiment, further includes a center-of-gravity position calculation process, in which a center-of-gravity position of an operation menu, and a center-of-gravity position of a circumscribed figure to the non-overlapping area are calculated, and the display process displays an operation menu such that the center-of-gravity position of the operation menu overlap the center-of-gravity position of the circumscribed figure. In this manner, the operation menu control program displays the operation menu such that the center of the non-overlapping area matches the center of the operation menu. Thereby, it becomes possible for the user to detect an item located near the operation object more easily, and to detect an item corresponding to the desired operation object more easily and promptly.

Also, in the operation menu control processing according to the present embodiment, the display process does not change the display position of an operation object, but changes the display position of the operation menu, and displays the operation menu. Thereby, it is possible for the operation menu control program to display the operation menu at a position that allows detecting an item located near an operation object while the display contents including at least operation objects are fixed at the display position more easily. Thereby, it becomes possible for the user to promptly detect an item corresponding to a desired operation object.

Alternatively, in the operation menu control processing according to the present embodiment, the display process displays the operation menu at a certain display position, and changes the display position of the operation objects to display the operation objects. Thereby, it is possible for the operation menu control program to fix the operation menu at the display position, and to move the display contents including at least operation objects to a position that allows an operation object located near the item to be easily detected. Thereby, it becomes possible for the user to detect an item corresponding to a desired operation object promptly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling an operation menu executed by a computer, the method comprising:
extracting a plurality of operation objects located within a certain range from a cursor position on a display screen; and
on the basis of a distance between each of the plurality of operation objects and a corresponding one of a plurality of items displayed as the operation menu, setting corresponding relationships between the plurality of operation objects and the plurality of items.

2. The method of controlling the operation menu according to claim 1, wherein the corresponding relationships are set such that a sum total of individual distances between each of the plurality of operation objects and a corresponding one of the plurality of items becomes minimum.

3. The method of controlling the operation menu according to claim 1, further comprising:
setting a part of or all of display areas of the plurality of operation objects as a non-overlapping area;
calculating a size of the operation menu in proportion to the non-overlapping area; and
displaying the operation menu with the size in a non-overlapping manner with the non-overlapping area.

4. The method of controlling the operation menu according to claim 3, wherein the size is in proportion to a size of a circumscribed figure to the non-overlapping area.

5. The method of controlling the operation menu according to claim 1, wherein the operation menu is displayed with a size specified in advance, and
the method further comprising:
when the plurality of operation objects are displayed on the display screen with a first size, setting a part of or all of display area of the plurality of operation objects as a non-overlapping area;
setting a second size of the plurality of operation objects in inverse proportion to a size of the non-overlapping area; and
displaying the plurality of operation objects having the second size, and the operation menu disposed at a position not overlapping with the non-overlapping area.

6. The method of controlling the operation menu according to claim 3, wherein the plurality of operation objects include characteristic strings individually indicating corresponding operation contents, and
the non-overlapping area individually includes starting positions of the characteristic strings in the plurality of operation objects.

7. The method of controlling the operation menu according to claim 3, further comprising:
calculating a first center-of-gravity position of the operation menu, and a second center-of-gravity position of a circumscribed figure to the non-overlapping area; and
displaying the operation menu such that the first center-of-gravity position and the second center-of-gravity position overlap each other.

8. The method of controlling the operation menu according to claim 1, wherein the operation menu has a shape surrounding the plurality of operation objects.

9. The method of controlling the operation menu according to claim 1, further comprising:
displaying the operation menu including the plurality of items on the display screen; and
displaying a guide display indicating the corresponding relationships between the plurality of operation objects and the plurality of items on the display screen.

10. An apparatus comprising:
a memory; and
a processor coupled to the memory and configured to:
extract a plurality of operation objects located within a certain range from a cursor position on a display screen, and
on the basis of a distance between each of the plurality of operation objects and a corresponding one of a plurality of items displayed as an operation menu, set corresponding relationships between the plurality of operation objects and the plurality of items.

11. The apparatus according to claim 10, wherein the corresponding relationships are set such that a sum total of individual distances between each of the plurality of operation objects and a corresponding one of the plurality of items becomes minimum.

12. The controlling apparatus according to claim 10, wherein the processor is further configured to:
set a part of or all of display areas of the plurality of operation objects as a non-overlapping area,
calculate a size of the operation menu in proportion to the non-overlapping area, and
display the operation menu with the size in a non-overlapping manner with the non-overlapping area.

13. The apparatus according to claim 12, wherein the size is in proportion to a size of a circumscribed figure to the non-overlapping area.

14. The apparatus according to claim 10, wherein the operation menu is displayed with a size specified in advance, and
the processor is further configured to:
when the plurality of operation objects are displayed on the display screen with a first size, set a part of or all of display area of the plurality of operation objects as a non-overlapping area,
set a second size of the plurality of operation objects in inverse proportion to a size of the non-overlapping area, and
display the plurality of operation objects having the second size, and the operation menu disposed at a position not overlapping with the non-overlapping area.

15. The apparatus according to claim 12, wherein the plurality of operation objects include characteristic strings individually indicating corresponding operation contents, and
the non-overlapping area individually includes starting positions of the characteristic strings in the plurality of operation objects.

16. The apparatus according to claim 12, wherein the processor is further configured to:
calculate a first center-of-gravity position of the operation menu, and a second center-of-gravity position of a circumscribed figure to the non-overlapping area, and
display the operation menu such that the first center-of-gravity position and the second center-of-gravity position overlap each other.

17. The apparatus according to claim 10, wherein the operation menu has a shape surrounding the plurality of operation objects.

18. The apparatus according to claim 10, wherein the processor is further configured to:
display the operation menu including the plurality of items on the display screen, and
display a guide display indicating the corresponding relationships between the plurality of operation objects and the plurality of items on the display screen.

19. A computer-readable recording medium storing a program for causing a computer to execute a process, the process comprising:
extracting a plurality of operation objects located within a certain range from a cursor position on a display screen; and
on the basis of a distance between each of the plurality of operation objects and a corresponding one of a plurality of items displayed as an operation menu, setting corresponding relationships between the plurality of operation objects and the plurality of items.
